(19) United States
(12) Patent Application Publication
(10) Pub. No.: US 2021/0204687 A1
(43) Pub. Date: Jul. 8, 2021

(54) TABLE WITH PORCELAIN-ENAMELED STEEL TABLETOP

(71) Applicant: MOORECO, INC., Temple, TX (US)

(72) Inventors: RYAN HAASE, TEMPLE, TX (US); GREG MOORE, TEMPLE, TX (US); ROLLAND LOW, TEMPLE, TX (US); JAIRO ZHU, POMONA, CA (US)

(73) Assignee: MOORECO, INC., Temple, TX (US)

(21) Appl. No.: 16/734,795

(22) Filed: Jan. 6, 2020

(51) Int. Cl. A47B 17/02; A47B 13/10; A47B 13/08; A47B 9/10; A47B 9/20; A47B 17/00; B43L 1/00

(52) U.S. Cl. CPC A47B 17/02; A47B 13/10; A47B 13/086; A47B 13/083; A47B 2200/0051; A47B 9/20; A47B 17/003; B43L 1/002; A47B 9/10

(57) ABSTRACT

The table with a porcelain-enameled steel tabletop provides a magnetic, erasable writing surface directly on the tabletop. The tabletop is defined by opposed upper and lower surfaces and a peripheral side edge, and is formed from porcelain-enameled steel. The porcelain-enameled steel may include a steel layer, having opposed upper and lower surfaces, and a porcelain layer enameled on the upper surface of the steel layer. The porcelain layer defines the upper surface of the tabletop, providing the magnetic, erasable writing surface. At least one leg is secured to the lower surface of the tabletop and extends downwardly therefrom. A protective strip may be secured to, and cover, the peripheral side edge of the tabletop. The protective strip may further be secured to, and cover, a portion of the upper surface of the tabletop and a portion of the lower surface of the tabletop.

### BACKGROUND

### 1. Field

The disclosure of the present patent application relates to tables and tabletops, and particularly to a table with a porcelain-enameled steel tabletop for providing a magnetic, erasable writing surface directly on the tabletop.

### 2. Description of the Related Art

In collaborative environments, such as classrooms, for example, it is common for students to push their desks together, or otherwise interlink their desks, in order to easily share classroom materials. Although such an arrangement provides an integrated work surface for each of the students to share, written projects and artwork still require papers, sketchbooks, workbooks and the like to be passed from one student to the next. It would be desirable to be able to provide a shared writing surface combined with the shared, collaborative desk arrangement.

Further, even when desks are being used individually in a non-collaborative manner, there are numerous occasions when it would be useful and/or enjoyable to take advantage of the desk's entire surface as a writing surface itself, rather than requiring the use of paper, sketchbooks, workbooks, etc. It would be clearly desirable to be able to provide the convenience of a conventional erasable whiteboard with a traditional desk or table. Thus, a table with a porcelain-enameled steel tabletop solving the aforementioned problems is desired.

### SUMMARY

The table with a porcelain-enameled steel tabletop provides a magnetic, erasable writing surface directly on the tabletop. The tabletop is defined by opposed upper and lower surfaces and a peripheral side edge, and is formed from porcelain-enameled steel. The porcelain-enameled steel may include a steel layer, having opposed upper and lower surfaces, and a porcelain layer enameled on the upper surface of the steel layer. The porcelain layer defines the upper surface of the tabletop, providing the magnetic, erasable writing surface. It should be understood that the term “table” is used broadly to describe an elevated surface supported by one or more legs or supports. Thus, it is intended that the tabletop may be used in combination with any desired configuration of table, desk or other supporting furniture.

The tabletop may further include a particle board layer, having opposed upper and lower surfaces, such that the lower surface of the steel layer is secured to the upper surface of the particle board layer. A backing layer may further be secured to the lower surface of the particle board layer.

At least one leg is secured to the lower surface of the tabletop and extends downwardly therefrom. A protective strip may be secured to, and cover, the peripheral side edge of the tabletop. The protective strip may further be secured to, and cover, a portion of the upper surface of the tabletop and a portion of the lower surface of the tabletop.

As a non-limiting example, the peripheral side edge of the tabletop may have at least one convex side and at least one concave side, where a radius of curvature of the at least one convex side is equal to a radius of curvature of the at least one concave side. As a further non-limiting example, the at least one convex side may be defined by two adjacent convex sides and, similarly, the at least one concave side may be defined by two adjacent concave sides. In this non-limiting exemplary configuration, multiples ones of the tables are easily interconnectable, with one of the convex sides of one table mating with one of the concave sides of an adjoining table. Thus, multiple ones of the tables may be releasably mated with one another to form a variety of different collabortive configurations.

These and other features of the present subject matter will become readily apparent upon further review of the following specification.

### BRIEF DESCRIPTION OF THE DRAWINGS

FIG. 1 is a perspective view of a table with a porcelain-enameled steel tabletop.

FIG. 2 is a partial side view in section of a tabletop of the table with a porcelain-enameled steel tabletop.

FIG. 3 is a top view of the table with a porcelain-enameled steel tabletop.

FIG. 4A diagrammatically illustrates an exemplary configuration of multiple ones of the table with a porcelain-enameled steel tabletop, along with associated seats, arranged in a collaborative configuration.

FIG. 4B diagrammatically illustrates another exemplary configuration of multiple ones of the table with a porcelain-enameled steel tabletop, along with associated seats, arranged in another collaborative configuration.

FIG. 4C diagrammatically illustrates still another exemplary configuration of multiple ones of the table with a porcelain-enameled steel tabletop, along with associated seats, arranged in still another collaborative configuration.

FIG. 4D diagrammatically illustrates yet another exemplary configuration of multiple ones of the table with a porcelain-enameled steel tabletop, along with associated seats, arranged in yet another collaborative configuration.

FIG. 5 is a perspective view of an alternative embodiment of the table with a porcelain-enameled steel tabletop.

FIG. 6A is a partial bottom perspective view of another alternative embodiment of the table with a porcelain-enameled steel tabletop in combination with a tote box.

FIG. 6B is a partial bottom perspective view of the table with a porcelain-enameled steel tabletop of FIG. 6A in combination with an enclosed book box.

FIG. 6C is a partial bottom perspective view of the table with a porcelain-enameled steel tabletop of FIG. 6A in combination with a wire frame book box.

FIG. 7 is a perspective view of another alternative embodiment of the table with a porcelain-enameled steel tabletop.

FIG. 8 is a perspective view of still another alternative embodiment of the table with a porcelain-enameled steel tabletop.

FIG. 9 is a perspective view of yet another alternative embodiment of the table with a porcelain-enameled steel tabletop.

FIG. 10 is a perspective view of another alternative embodiment of the table with a porcelain-enameled steel tabletop.

Similar reference characters denote corresponding features consistently throughout the attached drawings.

### DETAILED DESCRIPTION OF THE PREFERRED EMBODIMENTS

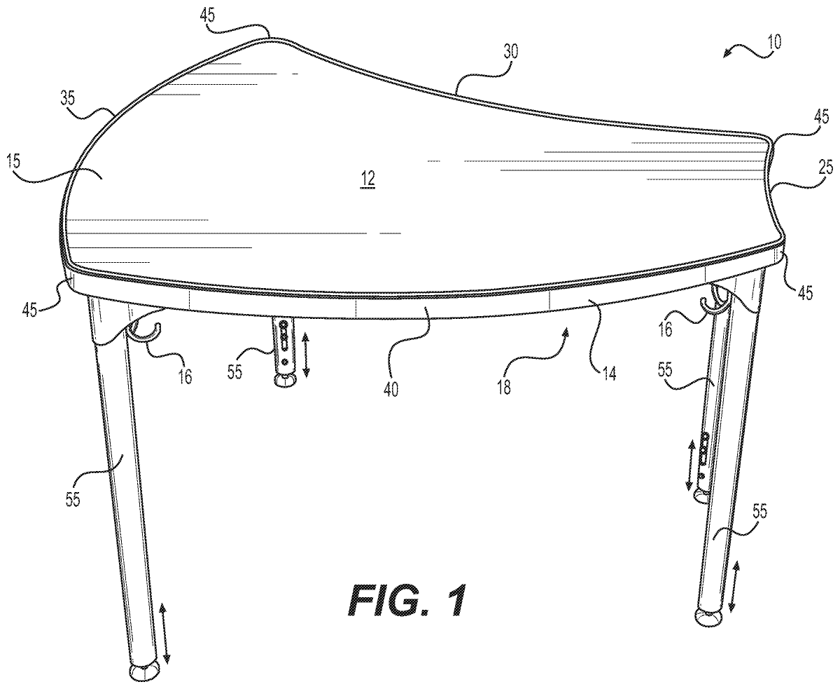

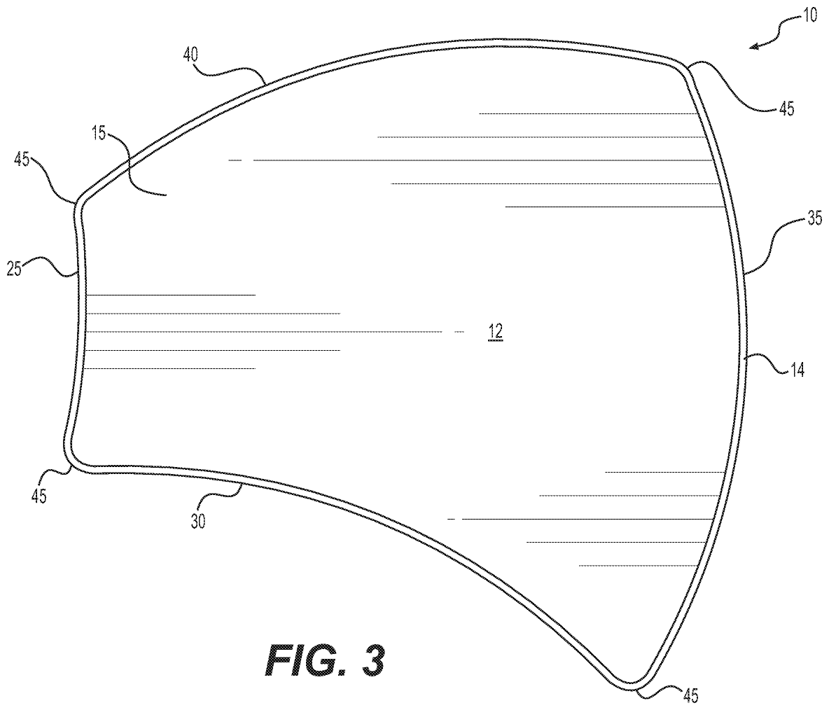

Referring now to FIGS. 1 and 3, the table with a porcelain-enameled steel tabletop 10 provides a magnetic, erasable writing surface 12 directly on the tabletop 15. As will be discussed in greater detail below, the overall configuration, size, shape and relative dimensions of the table with a porcelain-enameled steel tabletop 10 are shown in FIGS. 1 and 3 for exemplary and illustrative purposes only, and tabletop 15, as will be discussed in greater detail below, may be used in combination with any suitable type of desk or table, and may have any desired size, shape and relative dimensions. Further, it should be understood that the term “table” is used herein to broadly describe an elevated surface, which may be horizontally oriented and substantially planar, supported by one or more legs or supports. Thus, it is intended that the tabletop 15 may be used in combination with any desired configuration of table, desk or other supporting furniture.

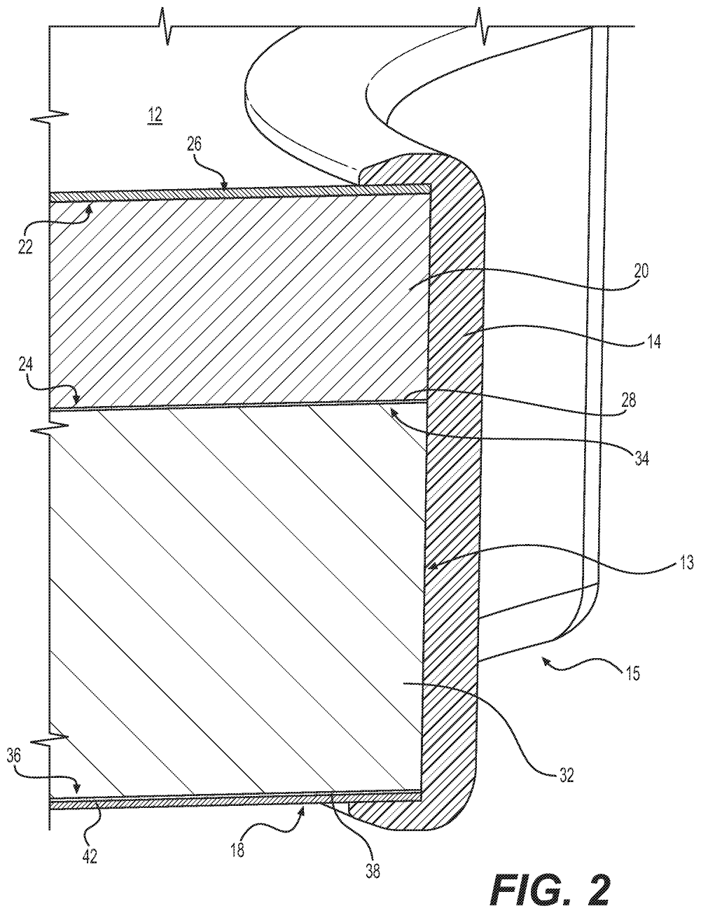

As best shown in FIG. 2, the tabletop 15 is defined by opposed upper and lower surfaces 12, 18, respectively, and a peripheral side edge 13. In order to provide a magnetic, erasable writing surface, similar to a magnetic whiteboard or the like, tabletop 15 is at least partially formed from porcelain-enameled steel. It should be understood that any suitable type of porcelain-enameled steel may be used. As a non-limiting example, the porcelain-enameled steel layer of tabletop 15 may be e³ CeramicSteel, manufactured by the Polyvision® Corporation of Johns Creek, Ga., which provides a magnetic surface which can be written on with dry-erase, semi-permanent, water-soluble or permanent markers without damaging the writing surface. e³ CeramicSteel writing surfaces are formed from a steel core of light gauge, covered on both sides with thin enamel coatings. The ceramic finish is fused to the steel at a temperature in the range of 700-900° C.

In the non-limiting example of FIG. 2, the porcelain-enameled steel layer includes a steel layer 20, having opposed upper and lower surfaces 22, 24, respectively, and a porcelain layer 26 enameled on the upper surface 22 of steel layer 20. The porcelain layer 26 defines the upper surface 12 of the tabletop 15, providing the magnetic, erasable writing surface; i.e., the layer of porcelain-enameled steel is not only similar to a conventional dry erase-type board, but is also paramagnetic, allowing for retention of magnets and accessories containing magnets and magnetic elements. It should be understood that the relative thicknesses of steel layer 20 and porcelain layer 26 are shown for exemplary and illustrative purposes only.

The tabletop 15 may further include a particle board layer 32, having opposed upper and lower surfaces 34, 36, respectively, such that the lower surface 24 of the steel layer 20 is secured to the upper surface 34 of the particle board layer 32. A backing layer 42 may further be secured to the lower surface 36 of the particle board layer 32. In FIG. 2, lower surface 24 of steel layer 20 is shown secured to upper surface 34 of particle board layer 32 by a layer of adhesive 28. Similarly, backing layer 42 is shown secured to the lower surface 36 of particle board layer 32 by layer of adhesive 38. It should be understood that the layers of adhesive 28, 38 are shown for exemplary purposes only and that any suitable method of attachment may be used. Further, it should be understood that particle board layer 32 may be replaced by a layer of any desired substrate material. Further, it should be understood that the relative thicknesses of particle board layer 32, backing layer 42 and the layers of adhesive 28, 38 are shown in FIG. 2 for exemplary and illustrative purposes only. It should be understood that backing layer 42 may be formed from any suitable type of material, such as, but not limited to, plastic, paperboard, cardboard, paper or the like.

Returning to FIG. 1, at least one leg 55 is secured to the lower surface 18 of the tabletop 15 and extends downwardly therefrom. In the non-limiting example of FIG. 1, four such legs 55 are shown positioned at four corners of tabletop 15, and legs 55 are shown as being telescopically adjustable with conventional end caps, serving as non-mobile bases. However, it should be understood that legs 55 are shown for exemplary purposes only and, as will be described in greater detail below, any suitable type, style, configuration and number of legs may be used.

Additionally, a protective strip 14 may be secured to, and cover, the peripheral side edge 13 of the tabletop 15. As best seen in FIG. 2, the protective strip 14 may further be secured to, and cover, a portion of the upper surface 12 of the tabletop and a portion of the lower surface 18 of tabletop 15, forming protective rims about the peripheries of upper and lower surfaces 12, 18. It should be understood that protective strip 14 may be formed from any suitable type of material. As a non-limiting example, protective strip 14 may be formed from a polypropylene and thermoplastic rubber mixture.

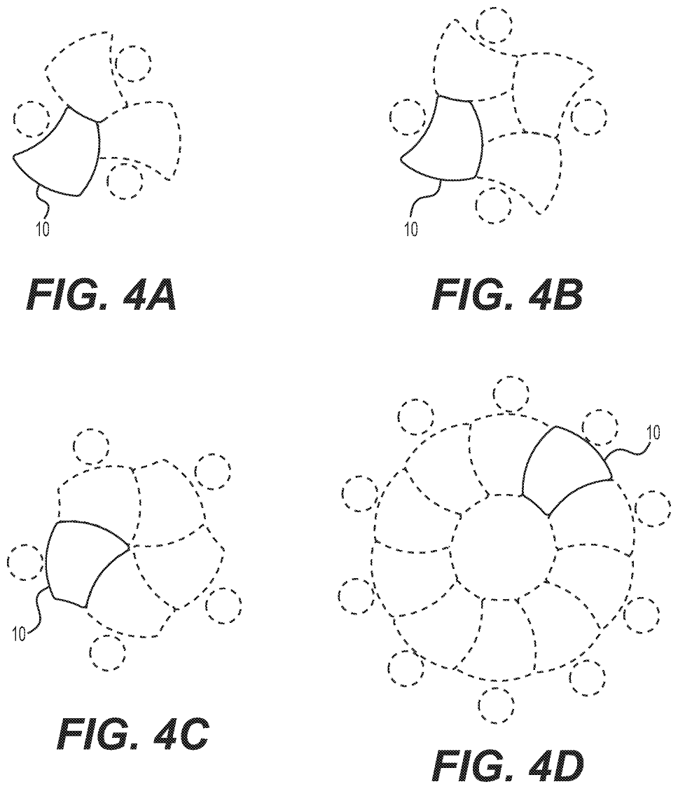

As discussed above, tabletop 15 may have any desired size, shape and relative dimensions. In the non-limiting example of FIGS. 1-3, the peripheral side edge 13 of tabletop 15 includes two adjacent convex sides 35, 40 and two adjacent concave sides 25, 30, where each of sides 25, 30, 35, 40 has an identical radius of curvature. This equality between the radii of curvature allows multiple ones of the tables 10 to be easily interconnectable, with one of the convex sides of one table mating with one of the concave sides of an adjoining table. Thus, multiple ones of the tables 10 may be releasably mated with one another to form a variety of different collaborative configurations, as illustrated in the examples of FIGS. 4A, 4B, 4C and 4D. In order to provide similar interconnectability, it should be understood that any suitable contouring of tabletop 15 may be used, including at least one convex side and at least one concave side having equal radii of curvature.

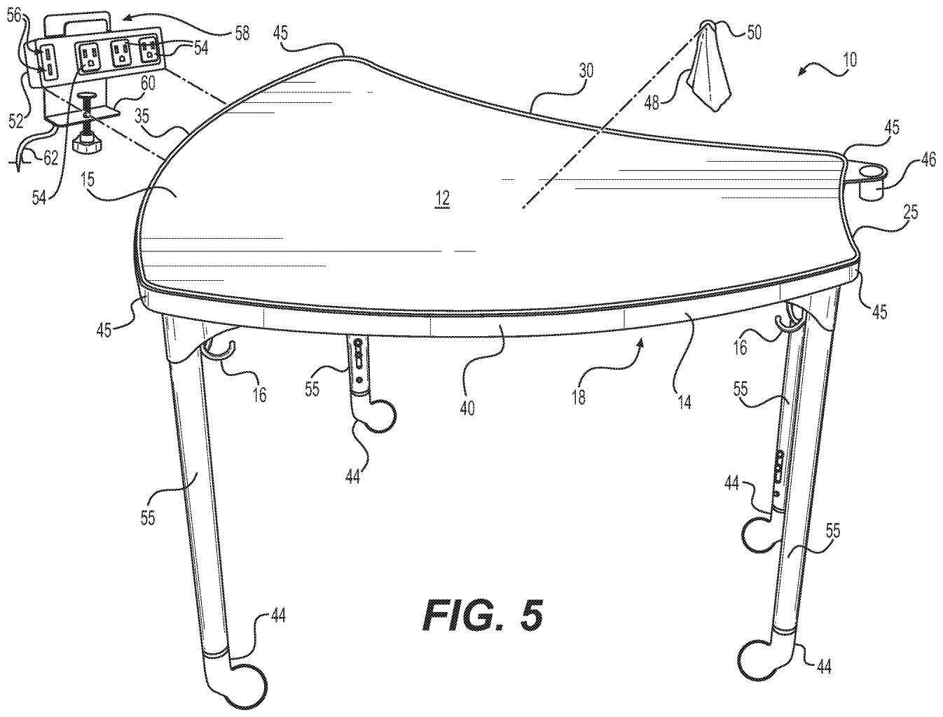

It should be further understood that the table with a porcelain-enameled steel tabletop 10 may be used in combination with any desired accessories. For example, as shown in FIG. 5, the table with a porcelain-enameled steel tabletop 10 includes one or more hooks 16, mounted to lower surface 18 of tabletop 15, for hanging book bags or the like, a cup holder 46 mounted on tabletop 15, and an eraser cloth 48, for erasing dry erase marker writing or the like, coupled with a magnet 50 to releasably retain the eraser cloth 48 to upper surface 12 of tabletop 15. Additionally, as shown, the non-mobile bases of legs 55 have been replaced by exemplary castors 44 in the non-limiting example of FIG. 5. Further, power supply module 52 is shown for providing power via conventional outlets 54 and universal serial bus (USB) ports 56. Power supply module 52 is shown being configured for releasable attachment to tabletop 15 by a clamp 60, and is further shown being provided with retainers 58 for supporting a smartphone, a tablet or the like. It should be understood that the overall configuration of power supply module 52 (and its attached power cord 62) is shown for exemplary purposes only. Similarly, it should be understood that the overall appearance and configuration of castors 44, cup holder 46 and eraser cloth 48 (and its associated magnet 50) are shown for exemplary purposes only, and that FIG. 5 is meant to show that any desired type of accessory may be used in combination with table 10, rather than being limited solely to the particularly illustrated accessories.

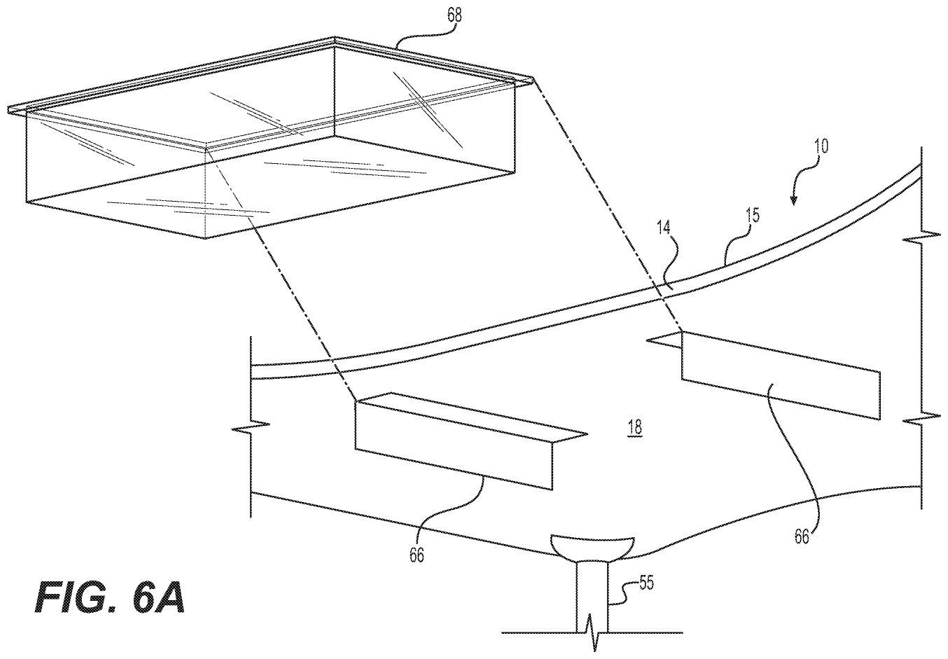

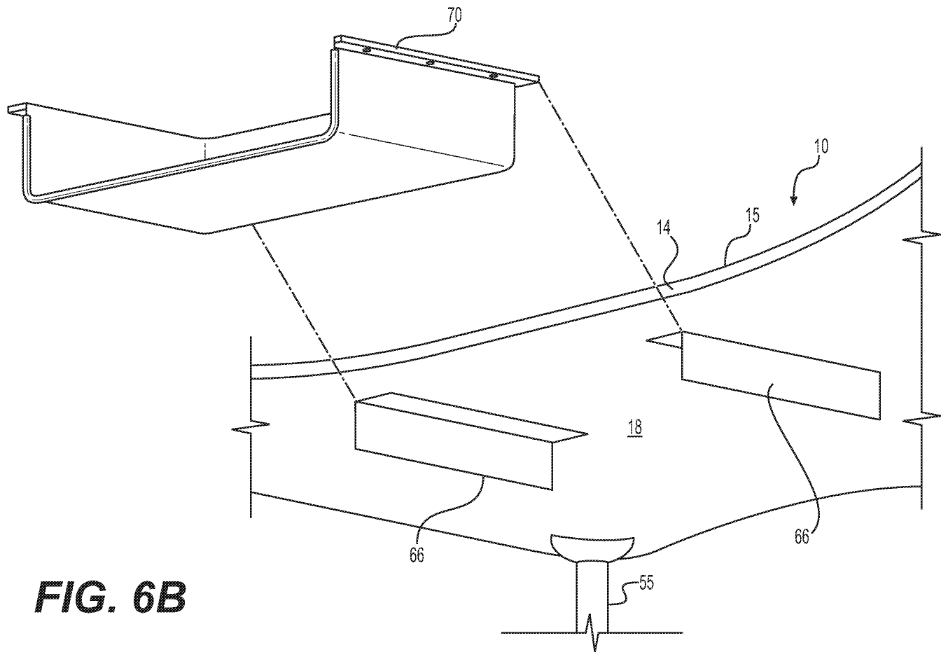

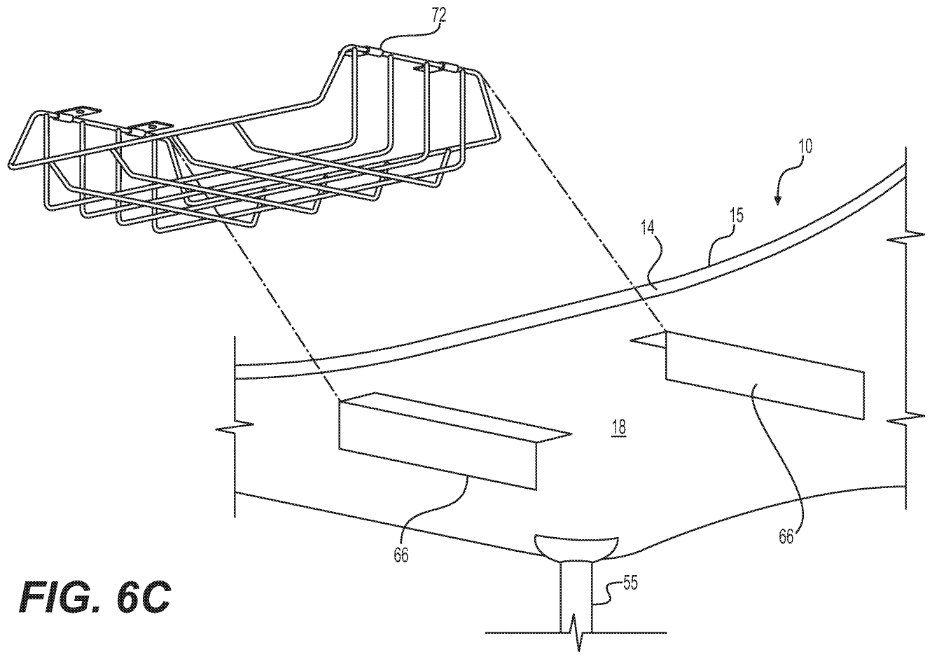

FIGS. 6A, 6B and 6C illustrate another non-limiting example of an accessory that may be used in combination with the table with a porcelain-enameled steel tabletop 10. Brackets 66 are attached to the lower surface 18 of tabletop 15, such that the brackets 66 define rails. In FIG. 6A, an exemplary tote box 68 is shown being slidably received by brackets 66 for removable storage. In FIG. 6B, tote box 68 has been replaced by an exemplary partially enclosed box 70 for receiving books, school supplies or the like. In FIG. 6C, the partially enclosed box 70 has been replaced by an exemplary wire frame box 72. It should be understood that the overall contouring, configuration, size, shape and relative dimensions of brackets 66 and boxes 68, 70, 72 are shown for exemplary purposes only. Further, it should be understood that brackets 66 may be secured to lower surface 18 of tabletop 15 by any suitable type of attachment, such as screws, bolts or the like.

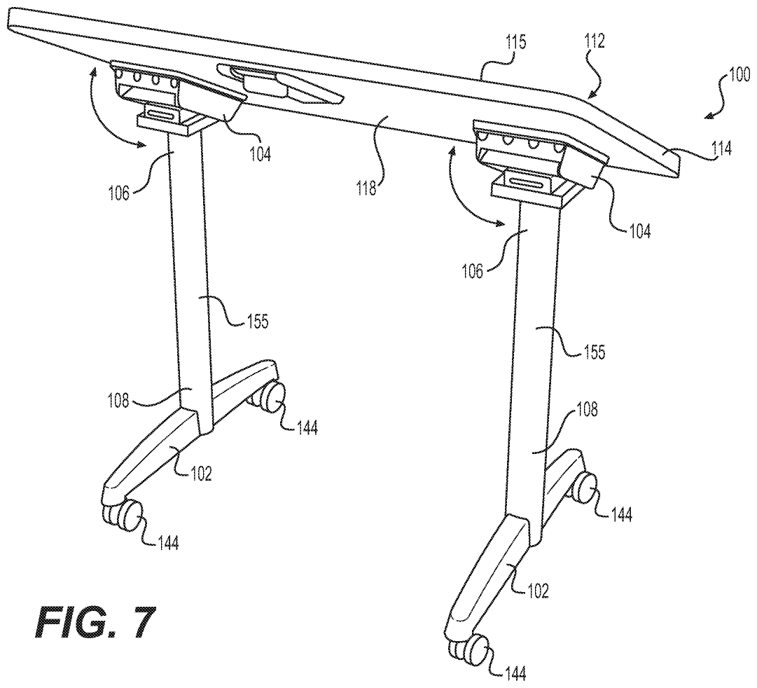

As discussed above, the porcelain-enameled steel tabletop may be used in tables having any desired overall configuration, size, shape and relative dimensions. In the further non-limiting example of FIG. 7, the table with a porcelain-enameled steel tabletop 100 includes a tabletop 115 having a similar construction to tabletop 15 of the previous embodiment, however, tabletop 115 is shown with alternative non-limiting contouring and relative dimensions. Similar to the previous embodiment, tabletop 115 includes a layer of porcelain-enameled steel, and is defined by an upper surface 112, a lower surface 118, and a peripheral side edge which may, similar to the previous embodiment, be covered by a protective strip 114.

In the non-limiting example of FIG. 7, the four legs 55 of the previous embodiment have been replaced by a pair of legs 155, each having an upper end 106 and a lower end 108. The upper ends 106 are pivotally secured to the lower surface 118 of tabletop 115 by hinge mechanisms 104, thus providing tabletop 115 with a “flip-top” configuration. In the non-limiting example of FIG. 7, the lower ends 108 of legs 155 are mounted on bases 102, which support castors 144. It should, however, be understood that legs 155, bases 102 and castors 144 are shown for exemplary purposes only.

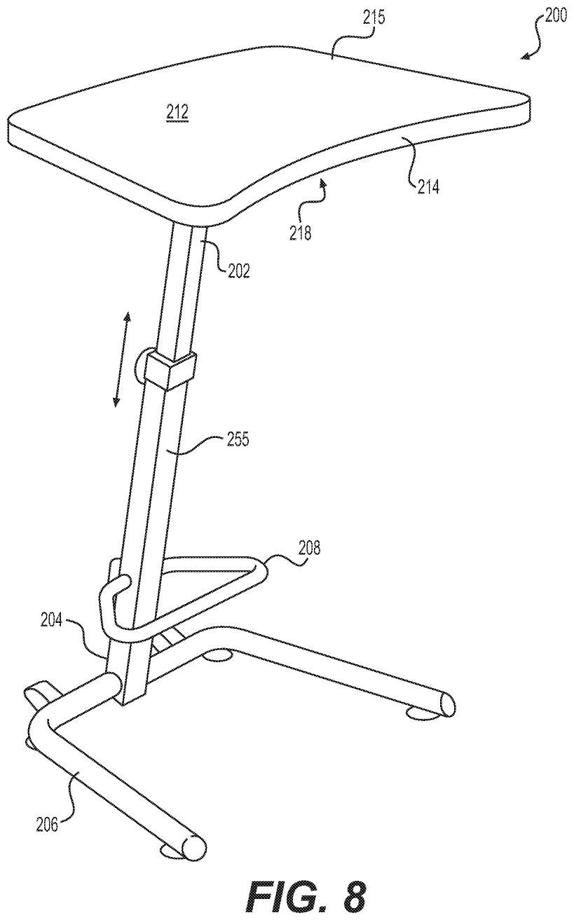

FIG. 8 illustrates another non-limiting example of the porcelain-enameled steel tabletop in use with a table having another alterative exemplary appearance and configuration. In the non-limiting example of FIG. 8, the table with a porcelain-enameled steel tabletop 200 includes a tabletop 215 having a similar construction to the tabletops of the previous embodiments, however, tabletop 215 is shown with another non-limiting example of contouring and relative dimensions. Similar to the previous embodiments, tabletop 215 includes a layer of porcelain-enameled steel, and is defined by an upper surface 212, a lower surface 218, and a peripheral side edge which may be, similar to the previous embodiments, covered by a protective strip 214.

In the non-limiting example of FIG. 8, the multiple legs of the previous embodiments have been replaced by a single pneumatically adjustable support 255, having an upper end 202 and a lower end 204. The upper end 202 is secured to the lower surface 218 of tabletop 215 by any suitable type of attachment or mounting. In the non-limiting example of FIG. 8, the lower end 204 is mounted on base 206, and further includes a foot rest 208. It should, however, be understood that pneumatically adjustable support 255, base 206 and foot rest 208 are shown for exemplary purposes only.

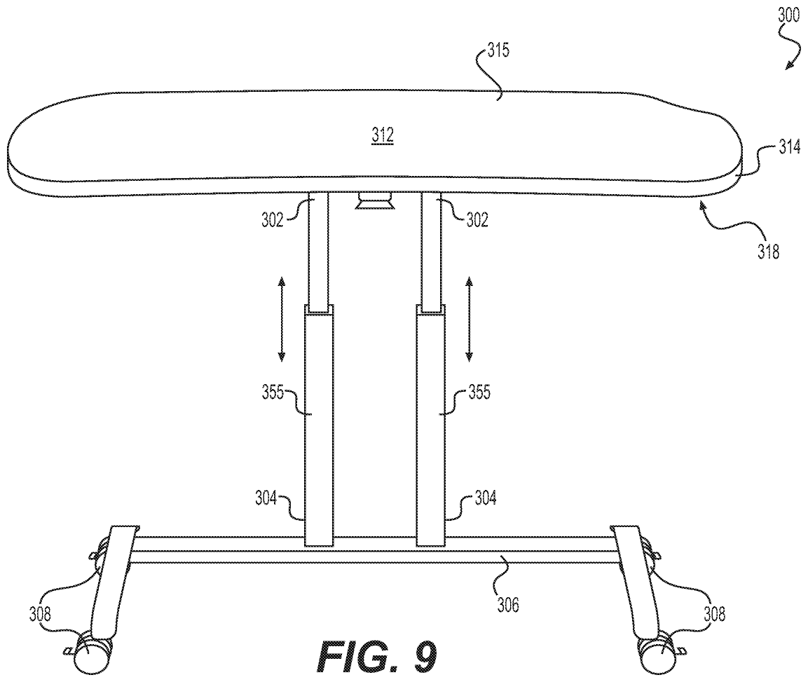

FIG. 9 illustrates still another non-limiting example of the porcelain-enameled steel tabletop in use with a table having yet another alternative exemplary appearance and configuration. In the non-limiting example of FIG. 9, the table with a porcelain-enameled steel tabletop 300 includes a tabletop 315 having a similar construction to the tabletops of the previous embodiments, however, tabletop 315 is shown with another non-limiting example of contouring and relative dimensions. Similar to the previous embodiments, tabletop 315 includes a layer of porcelain-enameled steel, and is defined by an upper surface 312, a lower surface 318, and a peripheral side edge which may be, similar to the previous embodiments, covered by a protective strip 314.

Similar to the embodiment of FIG. 8, table 300 is pneumatically adjustable, however, the single pneumatically adjustable support 255 of the previous embodiment has been replaced by a pair of pneumatically adjustable supports 355. Each of the pneumatically adjustable supports 355 has an upper end 302 and a lower end 304. The upper ends 302 are secured to the lower surface 318 of tabletop 315 by any suitable type of attachment or mounting. In the non-limiting example of FIG. 9, the lower ends 304 are mounted on base 306, which supports exemplary castors 308. It should, however, be understood that pneumatically adjustable supports 355, base 306 and castors 308 are shown for exemplary purposes only.

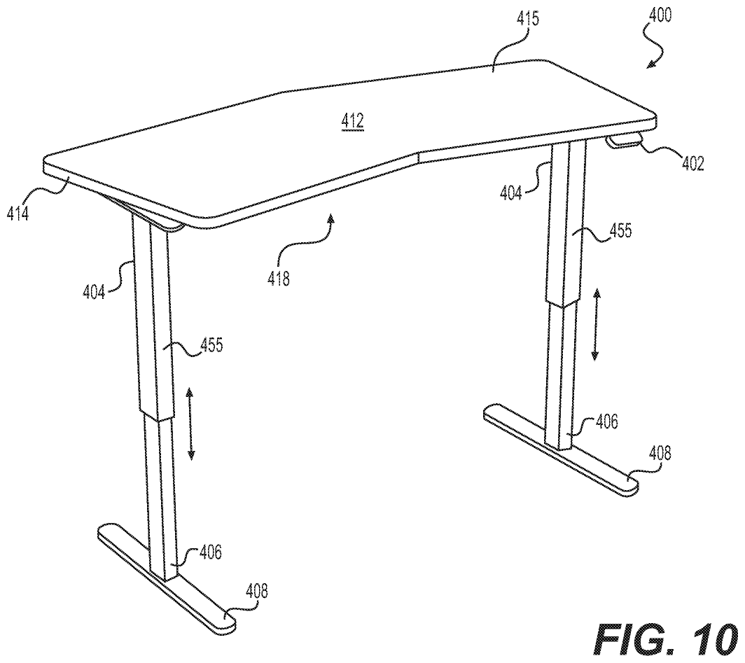

FIG. 10 illustrates another non-limiting example of the porcelain-enameled steel tabletop in use with a table having another alterative exemplary appearance and configuration. In the non-limiting example of FIG. 10, the table with a porcelain-enameled steel tabletop 400 includes a tabletop 415 having a similar construction to the tabletops of the previous embodiments, however, tabletop 415 is shown with still another non-limiting example of contouring and relative dimensions. Similar to the previous embodiments, tabletop 415 includes a layer of porcelain-enameled steel, and is defined by an upper surface 412, a lower surface 418, and a peripheral side edge which may be, similar to the previous embodiments, covered by a protective strip 414.

In the embodiment of FIG. 10, the pneumatically adjustable supports 255 and 355 have been replaced by a pair of electrically adjustable supports 455, which may be driven by any suitable type of motor, linear actuator or the like, and which may be controlled by control panel 402, which is shown in FIG. 10 as being mounted to tabletop 415. Each of the electrically adjustable supports 455 has an upper end 404 and a lower end 406. The upper ends 404 are secured to the lower surface 418 of tabletop 415 by any suitable type of attachment or mounting. In the non-limiting example of FIG. 10, the lower ends 406 are mounted on respective non-mobile bases 408. It should, however, be understood that electrically adjustable supports 455, bases 408 and control panel 402 are shown for exemplary purposes only.

It is to be understood that the table with a porcelain-enameled steel tabletop is not limited to the specific embodiments described above, but encompasses any and all embodiments within the scope of the generic language of the following claims enabled by the embodiments described herein, or otherwise shown in the drawings or described above in terms sufficient to enable one of ordinary skill in the art to make and use the claimed subject matter.

1. A table with a porcelain-enameled steel tabletop, comprising:
a tabletop having opposed upper and lower surfaces and a peripheral side edge, wherein the tabletop comprises porcelain-enameled steel, wherein the porcelain-enameled steel comprises a steel layer having opposed upper and lower surfaces, and a porcelain layer enameled on the upper surface of the steel layer, the porcelain layer defining the upper surface of the tabletop, and wherein the tabletop further comprises a nonmetal layer having opposed upper and lower surfaces, wherein the lower surface of the steel layer is secured to the upper surface of the nonmetal layer by a metal-to-nonmetal connection; and
at least one leg secured to the lower surface of the tabletop and extending downwardly therefrom.

2-3. (canceled)

4. The table with a porcelain-enameled steel tabletop as recited in claim 1, wherein the tabletop further comprises a backing layer secured to the lower surface of the nonmetal layer.

5. The table with a porcelain-enameled steel tabletop as recited in claim 1, wherein the tabletop further comprises a protective strip secured to and covering the peripheral side edge of the tabletop.

6. The table with a porcelain-enameled steel tabletop as recited in claim 5, wherein the protective strip is further secured to and covers a portion of the upper surface of the tabletop and a portion of the lower surface of the tabletop.

7. The table with a porcelain-enameled steel tabletop as recited in claim 1, wherein the peripheral side edge of the tabletop has at least one convex side and at least one concave side, wherein a radius of curvature of the at least one convex side is equal to a radius of curvature of the at least one concave side.

8. The table with a porcelain-enameled steel tabletop as recited in claim 7, wherein the at least one concave side comprises two adjacent concave sides.

9. The table with a porcelain-enameled steel tabletop as recited in claim 8, wherein the at least one convex side comprises two adjacent convex sides.

10. The table with a porcelain-enameled steel tabletop as recited in claim 1, wherein the at least one leg has opposed upper and lower ends, the upper end thereof being pivotally secured to the lower surface of the tabletop.

11. The table with a porcelain-enameled steel tabletop as recited in claim 10, wherein the at least one leg comprises a pair of legs.

12. The table with a porcelain-enameled steel tabletop as recited in claim 1, wherein the at least one leg has an adjustable height.

13. The table with a porcelain-enameled steel tabletop as recited in claim 12, wherein the at least one leg is telescopically adjustable.

14. The table with a porcelain-enameled steel tabletop as recited in claim 12, wherein the at least one leg is pneumatically adjustable.

15. A table with a porcelain-enameled steel tabletop, comprising:
a tabletop having opposed upper and lower surfaces and a peripheral side edge, wherein the tabletop comprises porcelain-enameled steel, the porcelain-enameled steel comprising a steel layer having opposed upper and lower surfaces, and a porcelain layer enameled on the upper surface of the steel layer, the porcelain layer defining the upper surface of the tabletop;
a nonmetal layer having opposed upper and lower surfaces, wherein the lower surface of the steel layer is secured to the upper surface of the nonmetal layer by a metal-to-nonmetal connection;
a protective strip secured to and covering the peripheral side edge of the tabletop, wherein the protective strip is further secured to and covers a portion of the upper surface of the tabletop and a portion of the lower surface of the tabletop; and
at least one leg secured to the lower surface of the tabletop and extending downwardly therefrom.

16-17. (canceled)

18. The table with a porcelain-enameled steel tabletop as recited in claim 15, wherein the tabletop further comprises a backing layer secured to the lower surface of the nonmetal layer.

19. A table with a porcelain-enameled steel tabletop, comprising:
a tabletop having opposed upper and lower surfaces and a peripheral side edge, the tabletop comprising porcelain-enameled steel, wherein the porcelain-enameled steel comprises a steel layer having opposed upper and lower surfaces, and a porcelain layer enameled on the upper surface of the steel layer, the porcelain layer defining the upper surface of the tabletop, and wherein the tabletop further comprises a nonmetal layer having opposed upper and lower surfaces, wherein the lower surface of the steel layer is secured to the upper surface of the nonmetal layer by a metal-to-nonmetal connection; and
at least one leg secured to the lower surface of the tabletop and extending downwardly therefrom.

20. The table with a porcelain-enameled steel tabletop as recited in claim 19, wherein the tabletop further comprises a backing layer secured to the lower surface of the nonmetal layer.

21. The table with a porcelain-enameled steel tabletop as recited in claim 19, wherein the tabletop further comprises a protective strip secured to and covering the peripheral side edge of the tabletop.

22. The table with a porcelain-enameled steel tabletop as recited in claim 21, wherein the protective strip is further secured to and covers a portion of the upper surface of the tabletop and a portion of the lower surface of the tabletop.

23. The table with a porcelain-enameled steel tabletop as recited in claim 1, wherein the nonmetal layer comprises particle board.

24. The table with a porcelain-enameled steel tabletop as recited in claim 15, wherein the nonmetal layer comprises particle board.

25. The table with a porcelain-enameled steel tabletop as recited in claim 19, wherein the nonmetal layer comprises particle board.
